(19) United States
(12) Patent Application Publication
(10) Pub. No.: US 2011/0000725 A1
(43) Pub. Date: Jan. 6, 2011

(54) HYBRID VEHICLE

(75) Inventors: Naoya Murota, Hamamatsu-shi (JP); Masakazu Ono, Hamamatsu-shi (JP); Fumihiko Takekoshi, Hamamatsu-shi (JP); Hiroyuki Konno, Hamamatsu-shi (JP)

Correspondence Address: MARSH, FISCHMANN & BREYFOGLE LLP, 8055 East Tufts Avenue, Suite 450, Denver, CO, 80237, US

(73) Assignee: SUZUKI MOTOR CORPORATION, Hamamatsu-shi (JP)

(21) Appl. No.: 12/830,024

(22) Filed: Jul. 2, 2010

(30) Foreign Application Priority Data
Jul. 6, 2009 (JP) 2009-159955

(51) Int. Cl. B60K 6/46

(52) U.S. Cl. 180/65.245; 903/930

(57) ABSTRACT

In a hybrid vehicle including an engine; a generator for generating electrical power from the engine; a battery charged with electrical power generated by the generator; and a motor driven by electrical power generated by the generator or by electrical power output by the battery, and with a view to reducing energy consumption from the battery without using complicated control operations while preventing overcharging of the battery, the hybrid vehicle further includes a motoring control unit for starting motoring, i.e., mechanical driving of the engine, in addition to regenerative power generation when a state of charge of the battery reaches a first set value and stopping the motoring of the engine when the state of charge of the battery reaches a second set value. A battery management unit is also provided for starting power generation from the engine when a state of charge of the battery becomes higher than a third set value and stopping the engine when the state of charge of the battery reaches a fourth set value. Engine motoring control during regeneration and control of power generation by the engine can be separately performed.

### FIELD OF THE INVENTION

The invention relates to a hybrid vehicle and particularly to a plug-in hybrid vehicle or a series hybrid vehicle capable of performing regenerative power generation utilizing a drive motor during deceleration.

### BACKGROUND OF THE INVENTION

Recently, much attention is being paid to hybrid vehicles which are capable of overcoming an inherent disadvantage of electric vehicles in that it is difficult to considerably increase range or travelling distance while at the same time reducing problems arising from exhaust gas and noise inherent to vehicles equipped with an engine.

Prior art in this area is exemplified by the following documents: Japanese published patent application No. 1984-204402, Japanese published patent application No. 1992-322105, discussed below, and Japanese published patent application No. 2004-312962. This latter document, Japanese published patent application No. 2004-312962, discloses a hybrid vehicle with two motors, in which power obtained through regenerative control of a motor applied with a braking force is consumed by the other motor.

The invention sets out to resolve the following problem. Heretofore, in a hybrid system including an engine for driving a generator, the generator directly connected to an output shaft of the engine, a battery and a drive motor, a disadvantageous situation arose in that if the amount of charge of the battery reaches the upper limit while electrical power is being regenerated by employing the drive motor as the generator during deceleration while maintaining generating braking power, overcharging of the battery occurs as a result of the amount of charge being increased by the regenerative power.

In order to avoid damage to the battery due to overcharging in the above-mentioned situation, in the system disclosed in Japanese published patent application No. 1984-204402, power generation by regeneration is stopped in the presence of a predetermined abnormal state of charge. However, when regeneration is stopped, another disadvantageous situation arises in that the load applicable to other braking means (foot brake, etc.) is increased.

In consideration of the above-mentioned disadvantages, Japanese published patent application No. 1992-322105 teaches a technique wherein regenerative power is partly consumed by driving a generator as a motor and by motoring the generator. In this disclosure of Japanese published patent application No. 1992-322105, the upper limit for the amount of charge of the battery is handled by using a predetermined voltage value as a threshold.

The method consisting in regenerative power consumption by motoring the engine aims at securing a braking force by regenerative braking while motoring the engine. However, the use of a voltage level as a threshold, which forms a condition for motoring the engine, involves the following disadvantages.

(1) Even in a case where the voltage value is equal to or more than the threshold, it cannot be determined whether the charging rate is currently increasing.

(2) In the case where the battery is a lithium ion battery, the method for detecting a charging rate on the basis of a voltage value may bring about other disadvantages.

(3) When using voltage as a threshold, it is necessary to establish a threshold with allowance for prevention of overcharging, which can lead to under-utilization of the chargeable capacity of the battery.

Likewise, in the case where motoring of the engine is “On/Off” controlled by using only one threshold, a disadvantageous situation arises in that drivability (in other words driver comfort) deteriorates as a result of motoring of the engine being frequently turned On/Off in a driving mode in the vicinity of the threshold.

Moreover, where the amount of charge in the battery reaches the upper limit and thus further charging of regenerative power to the battery would result in overcharging, ideally, regenerative power should be made equal to the power consumed by the generator. In practice, however, it is difficult to make the regenerative power completely equal to the power consumed. If the power consumed is less than the regenerative power, overcharging of the battery results.

### SUMMARY OF THE INVENTION

It is, therefore, an object of the present invention to provide a hybrid vehicle capable of reducing energy consumption from the battery without using complicated control operations, while preventing overcharging of the battery.

The present invention provides, in order to overcome the above disadvantages, a hybrid vehicle comprising an engine; a generator for generating electrical power from the driving force of the engine; a battery charged with electrical power generated by the generator; and a motor driven by electrical power generated by the generator or by electrical power output by the battery, the hybrid vehicle further comprising motoring control means for starting motoring of the engine in addition to regenerative power generation when a state of charge of the battery reaches a first set value and stopping the motoring of the engine when the state of charge of the battery reaches a second set value smaller than the first set value.

The motoring control means may be a computer-controlled unit with a processor capable of processing instructions for the desired control.

Accordingly, since motoring control of the engine at a time of regenerative power generation is performed as a function of the state of charge of the battery and since a threshold at the start of motoring control and a threshold at the end of motoring control are set to different values, it is possible to reduce energy consumption from the battery without using complicated control operations, while preventing overcharging of the battery.

### BRIEF DESCRIPTION OF THE DRAWINGS

FIG. 1 is a flowchart showing control of start/end of motoring of an engine in a hybrid vehicle.

FIG. 2 is a system block diagram in a hybrid vehicle.

FIG. 3 is a view showing levels of the SOC (state of charge) of the battery) and operation modes.

FIG. 4 is a flowchart showing control of the start/end of the charging operation in a hybrid vehicle.

FIG. 5 is a flowchart for abnormality processing in a hybrid vehicle.

### DETAILED DESCRIPTION OF A PREFERRED EMBODIMENT

One embodiment of the present invention will be described in detail hereinafter with reference to the accompanying drawings.

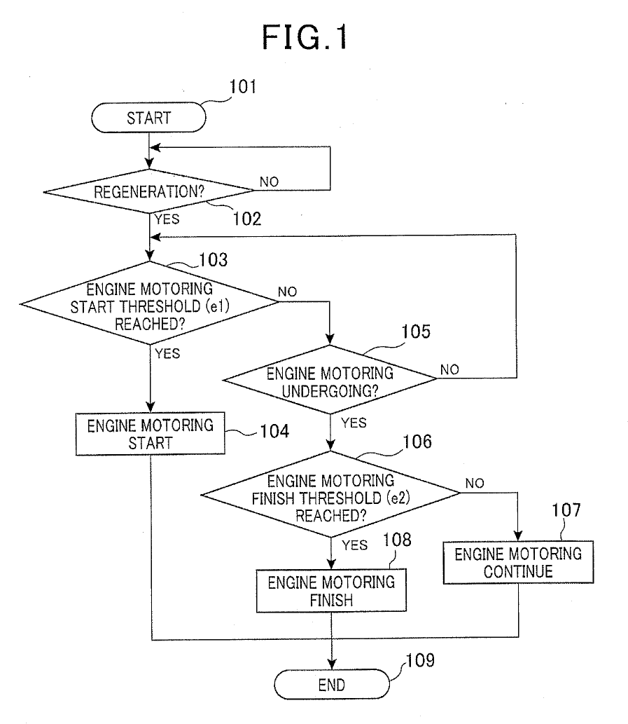

FIGS. 1 through 5 illustrate one embodiment of the present invention.

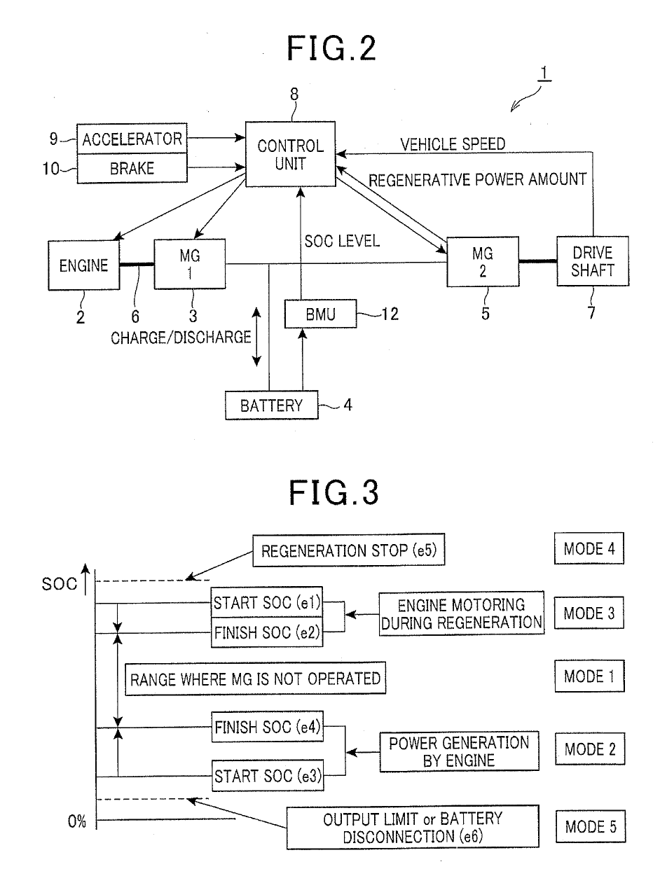

In FIG. 2, reference numeral 1 denotes a hybrid system in a hybrid vehicle consisting of a plug-in hybrid vehicle or a series hybrid vehicle (in a series hybrid vehicle, the engine is not connected to the wheels of the vehicle, it is only used to generate electricity which powers the electric motor and also feeds the battery).

This hybrid system 1 comprises an engine 2 mounted on the hybrid vehicle, a generator (also referred to as “MG1”) 3 for generating electrical power from the driving force of the engine 2, a battery 4 charged with electrical power generated by the generator 3 and a motor (also referred to as “MG2”) 5 driven by electrical power generated by the generator 3 or by electrical power output from the battery 4.

That is to say, as shown in FIG. 2, the generator 3 is connected, to an output shaft 6 of the engine 2, and the motor 5 is connected to a drive shaft 7 in communication with a drive wheel not shown.

The generator 3 is connected with the battery 4, and electrical power generated by the generator 3 from the driving force of the engine 2 is used to charge the battery 4.

Using electrical power from the generator 3 or electrical power discharged from the battery 4, the motor 5 drives drive shaft 7.

In more detail, the generator 3 generates power from the driving force of the engine 2 only in a region where a state of charge (also referred to as “SOC” or “charge ratio (%)”) is low. This is the result of the hybrid system 1 in the plug-in hybrid vehicle having the following characteristics:

(1) The battery 4 is charged from a home power supply using off-peak night-time electrical power, or the like.

(2) Travel is performed using electrical power from the battery 4 at an initial stage of travel (also referred to as “EV mode”).

(3) When the SOC of the battery 4 becomes lower than a preset lower limit, travel is achieved by starting the engine 2 and generating power from the generator 3 connected to the engine 2 and driving the drive shaft 7 by the motor 5 (this is also referred to as “hybrid mode”).

(4) When the SOC of the battery becomes higher than a preset SOC value of the battery 4, the engine 4 is stopped (transition to the EV mode).

Thus, one of the following conditions is satisfied:

(a) The engine 2 is not being rotated and the SOC of the battery 4 corresponds to nearly fully charged.

(b) The engine 2 is not being rotated and the SOC of the battery 4 still has allowance for a regenerative portion.

(c) The engine 2 is being rotated and the SOC of the battery 4 still has allowance.

In order to utilize a chargeable amount of the battery 4 to the utmost, it is necessary to arrange for the SOC of the battery 4 for starting motoring of the engine 2 to be as high as possible. Also, in order to prevent overcharging the battery 4, it is necessary for power consumption at the generator 3 to be set higher than regenerative power.

For the above reason, a small amount of electrical power is taken out from the battery 4 even during power regeneration. Therefore, if only one threshold is used for the motoring control of the engine 2, this results in a lowering of the SOC of battery 4 as a result of this amount of electrical power being taken from the battery, and the SOC of the battery 4 is reduced to a level below the threshold by motoring of the engine 2. The result is that motoring of the engine 2 is frequently repeatedly turned On/Off in the vicinity of the threshold and thus, drivability is deteriorated.

In view of the above, a method is currently in use for operating a vehicle using four thresholds and in three modes in conformity with the characteristics of a plug-in hybrid vehicle.

But in addition to this, in order to prevent overcharging, it is necessary to perform forced stopping (invalidation) of regenerative power generation just for the case where the SOC of the battery 4 keeps on increasing even after motoring of the engine 2.

Likewise, in order to prevent excessive discharge, it is necessary to disconnect the battery 4 when the SOC of the battery 4 falls below a usable lower limit value (the vehicle is now traveling only on electrical power produced by engine 2 and generator 3). Therefore, two additional thresholds are employed herein so that traveling can be performed using a total of six thresholds and in five modes.

The hybrid system 1 comprises a motoring control means (also referred to as “control unit”) 8 adapted to start motoring of the engine 2 in addition to regenerative power generation when the SOC, that is a state of charge of the battery 4, reaches a first set value e1 to bring it down to below first set value e1 and to stop motoring the engine 2 when the SOC reaches a second set value e2 that is lower than the first set value e1.

In more detail, the motoring control means 8 is, as shown in FIG. 2, connected with an accelerator pedal position sensor 9, a brake pedal position sensor 10 and a vehicle speed sensor.

The motoring control means 8 inputs a detection signal corresponding to the degree of depression of the accelerator pedal (not shown) produced by the accelerator pedal position sensor 9 and a detection signal corresponding to the degree of depression of a brake pedal (not shown) produced by the brake pedal position sensor 10, and also inputs a vehicle speed signal produced by the vehicle speed sensor 11 arranged near the drive shaft 7.

The motoring control means 8 is, as shown in FIG. 2, further connected with the engine 2, the generator 3, the battery 4 and the motor 5.

At this time, the battery 4 is connected with the motoring control means 8 through power generation control means (also referred to as “BMU” or “battery management unit”) 12.

The power generation control means may be a computer-controlled unit with a processor capable of processing instructions for the desired control.

The motoring control means 8 of the hybrid system 1 performs control such that motoring of the engine 2 is started in addition to regenerative power generation when the SOC, that is a state of charge of the battery 4, reaches the first set value e1 and motoring of the engine 2 is stopped when the SOC of the battery reaches the second set value 2e lower than the first set value e1.

In actual controlling practice, where motoring of the engine 2 is performed by regenerative power, a regenerative power generation amount as a function of vehicle speed is preliminarily obtained and a map is prepared.

During the time when charging of the battery 4 by regeneration is prohibited, motoring of the engine 2 is performed by the generator 3 such that power consumption will become equal to the amount of regenerative power generation from the map+α (α constant), in order to prevent overcharging of the battery 4.

Moreover, during regeneration, regenerative power is detected from time to time in accordance with voltage and current and a difference between the detected value and the value obtained using the map (excluding “+α”) is added to the set value for power consumption of generator 3 in order to cope with any accidental variation (especially an increase) in regenerative power during motoring of the engine 2.

When the SOC level becomes lower than the second set value e2 corresponding to a finish SOC value for motoring of the engine during regeneration as later described, the motoring control of the engine 2 is stopped and regenerative power is once again used to charge the battery.

For starting regeneration, regeneration is performed corresponding to engine braking demand resulting from reduction of accelerator opening and/or operation of a brake pedal.

Power consumption by motoring of the engine 2 performed by the motoring control means 8 is set to be higher than the amount of power generated as a result of regenerative power generation.

By virtue of the foregoing arrangement, overcharging the battery 4 is prevented and a long service life of a battery is ensured.

Furthermore, the power generation control means 12 performs control such that the engine 2 is operated to start power generation when the SOC, that is a state of charge of the battery 4, exceeds a third set value e3 that is lower than the second set value e2 and the engine 2 is stopped when the SOC reaches a fourth set value e4 also lower than the second set value e2.

By virtue of the foregoing arrangement, engine motoring control during regeneration and power generation control for engine 2 can be separately performed as a function of the SOC of the battery 4.

In more detail, the hybrid system 1 is provided with six thresholds and five modes depending on SOC, that is the state of charge of the battery 4, as shown in FIG. 3.

The six thresholds are as follows.

First threshold: a first set value e1 wherein the SOC is a start SOC for starting engine motoring control during regeneration.

Second threshold: a second set value e2 wherein the SOC is a finish SOC for finishing engine motoring control during regeneration.

Third threshold: a third set value e3 wherein the SOC is a start SOC for starting power generation control by the engine 2.

Fourth threshold: a fourth set value e4 wherein the SOC is a finish SOC for finishing a power generation control by the engine 2.

Fifth threshold: a fifth set value e5 for stopping regeneration.

Sixth threshold: a sixth set value e6 for limiting output or for disconnecting the battery 4.

Those six thresholds have the following relation with one another.

e5>e1>e2>e4>e3>e6

The five modes are as follows.

Mode 1: a mode in a range where the generator (also referred to as “MG1”) 3 is not being operated and the motor (also referred to as “MG2”) is being operated.

Mode 2: a power generation by the engine 2 control mode.

Mode 3: an engine motoring control mode during regeneration.

Model 4: a mode for stopping regeneration

Mode 5: a mode for limiting output or for disconnecting the battery 4.

Power generation by the engine 2 is, as shown in FIG. 3, controlled to be performed only between the third set value e3 that is the start SOC and the fourth set value e4 that is the finish SOC, the third set value e3 being set in conformity with the battery 4 to be used.

At this time, if an interval between the third set value e3 that is the start SOC and the fourth set value e4 that is the finish SOC is small, the engine 2 is started at a time when the SOC level is low and a load is high and so, loss caused by charge and discharge of the battery 4 can be reduced.

Likewise, the engine motoring control during regeneration is, as shown in FIG. 3, performed only between the first set value e1 that is the start SOC and the second set value e2 that is the finish SOC.

Then, when the SOC level reaches the first set value e1 that is the start SOC, the motoring control of engine 2 by regenerative power is started.

As mentioned above, since the electrical power consumption resulting from motoring of the engine 2 is set to be higher than the regenerative power in order to prevent overcharging the battery 4, motoring of the engine 2 results in lowering of the SOC level.

The second set value e2 is consequently provided corresponding to the finish SOC so as to stop motoring of the engine 2 and start charging power into the battery 4 again.

Moreover, since regenerative power would not be consumed and the SOC would be increased in the event of power consumption by motoring of the engine 2 not being performed normally, for example, in the event of engine 2 and generator 3 being disconnected from each other, a fifth set value e5 is provided which is a fifth threshold so that regeneration is forcedly stopped (invalidated) by the power generation control means 12 when the SOC level reaches the fifth set value e5.

Likewise, in the event of SOC decreasing instead of increasing, even if power generation by the engine 2 is performed, for example, in the event of generator 3 performing badly, there is provided, in order to avoid ending up with a deeply discharged battery 4, the sixth set value e6 which is the sixth threshold as shown in FIG. 3, so that output limitation of the generator 5 and disconnection of the battery 4 are performed when the SOC level becomes lower than the sixth set value e6.

Operation will now be described with reference to a flowchart for controlling starting and stopping of motoring of the engine of the hybrid vehicle of FIG. 1.

When a program for controlling starting and stopping of motoring of the engine of the hybrid vehicle 1 is started (101), the procedure proceeds to a judgment (102) as to whether regeneration is currently occurring.

If the result of the judgment (102) is NO, the judgment (102) is repeatedly performed until the result of the judgment (102) becomes YES.

If the result of the judgment (102) is YES, the procedure proceeds to a judgment (103) as to whether the SOC has reached the engine motoring start threshold, i.e., the first set value e1 that is the start SOC.

If the result of the judgment (103) is YES, the procedure proceeds to a process (104) for starting motoring of the engine 2 and then, the procedure proceeds to a process (109) for ending the program for controlling starting and stopping of motoring of the engine as later described.

If the result of the judgment (103) as to whether the SOC has reached the engine motoring start threshold, i.e., the first set value e1 that is the start SOC, is NO, the procedure proceeds to a judgment (105) as to whether the engine motoring is currently occurring.

If the result of the judgment (105) is NO, the procedure returns to the judgment (103) as to whether the SOC has reached the engine motoring start threshold, i.e., the first set value e1 that is the start SOC.

If the result of the judgment (105) is YES, the procedure proceeds to a judgment (106) as to whether the SOC has reached the engine motoring finish threshold, i.e., the second set value e2 that is the finish SOC.

If the result of the judgment (106) is NO, the procedure proceeds to a process (107) for continuing engine motoring and thereafter, the procedure proceeds to a program end (109) for controlling the engine motoring start/finish.

If the judgment (106) is YES, the procedure proceeds to a process (108) for finishing the engine motoring and thereafter, the procedure proceeds to a program end (109) for controlling the engine motoring start/finish.

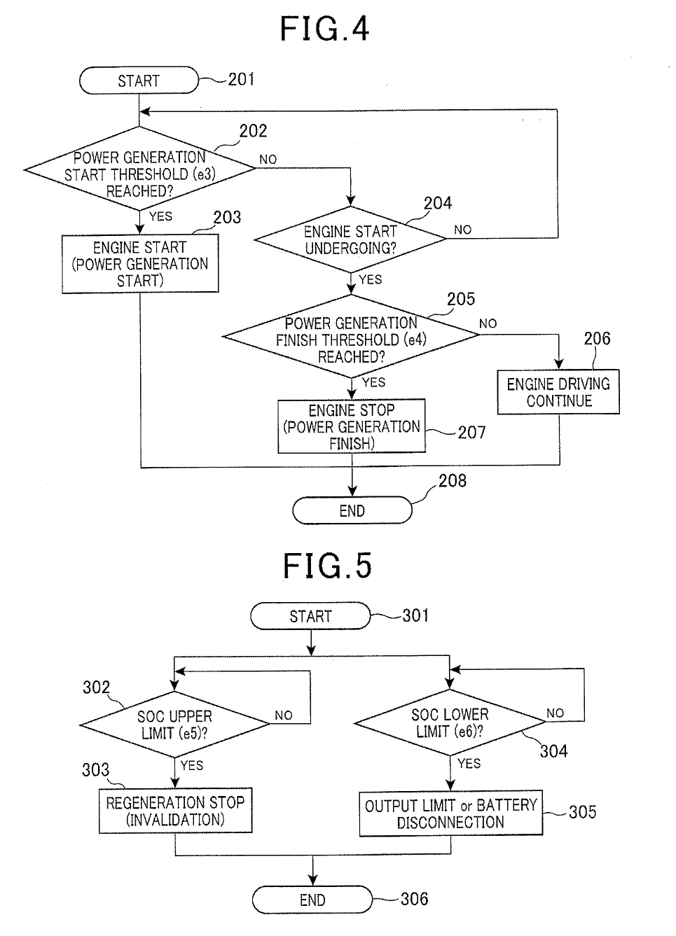

Operation will now be described with reference to the flowchart for controlling charge start/finish in a hybrid vehicle of FIG. 4.

When the program for controlling the charge start/finish in the hybrid system 1 is started (201), the procedure proceeds to a judgment (202) as to whether the SOC has reached the power generation start threshold, i.e., the third set value e3 that is the start SOC.

If the result of the judgment (202) is YES, the procedure proceeds to a process (203) for starting the engine 2 in order to start power generation and thereafter, the procedure proceeds to a program end (208) for controlling a charge start/finish as later described.

If the result of the judgment (202) is NO, the procedure proceeds to a judgment (204) as to whether the engine 2 is being started.

If the result of the judgment (204) is NO, the procedure returns to the judgment (202) as to whether the SOC has reached the power generation start threshold, i.e., the third set value e3 that is the start SOC.

If the result of the judgment (204) is YES, the procedure proceeds to a judgment (205) as to whether the SOC has reached the power generation finish threshold, i.e., the fourth set value e4 that is the finish SOC.

If the result of the judgment (205) is NO, the procedure proceeds to a process (206) for continuing running of the engine 2 and thereafter, the procedure proceeds to the end of the program for charge start/stop control (208).

If the result of the judgment (205) is YES, the procedure proceeds to a process (207) for stopping the engine 2 in order to finish power generation.

Operation will be further described with reference to the flowchart for abnormality processing in a hybrid vehicle of FIG. 5.

When the program for abnormality processing in a hybrid system 1 is started (301), processing of two systems is performed as a function of SOC.

In the first system, the procedure proceeds to a judgment (302) as to whether the SOC has reached the upper limit, i.e., the fifth set value e5 that is the fifth threshold.

If the result of the judgment (302) is NO, the judgment (302) is repeatedly made until the result of the judgment (302) becomes YES.

If the result of the judgment (302) is YES, the procedure proceeds to the process (303) for forcedly stopping (invalidating) regeneration by the power generation control means 12 and thereafter, the procedure proceeds to a program end (306) for abnormality processing as later described.

In the second system, the procedure proceeds to a judgment (304) as to whether the SOC has reached the lower limit, i.e., the sixth set value e6 that is the sixth threshold.

If the result of the judgment (304) is NO, the judgment is repeatedly made until the judgment (304) becomes YES.

If the result of the judgment (304) is YES, the procedure proceeds to a process (305) for performing output limiting of the generator 5 or disconnection of the battery 4 and thereafter, the procedure proceeds to a program end (306) for abnormality processing.

By virtue of the arrangement mentioned above, in a hybrid system 1 comprising the generator 3 for generating electrical power from the driving force of the engine 2, a battery 4 charged by the electrical power generated by the generator 3, and a motor 5 driven by the electrical power generated by the generator 3 or by electrical power output by the battery 4, the system 1 further comprises motoring control means 8 for starting motoring of the engine 2 in addition to regenerative power generation and stopping the motoring of the engine 2 when a state of charge of the battery 4 has reached the second set value e2 lower than the first set value e1.

Accordingly, since motoring control of the engine 2, performed during power regeneration, is carried out as a function of SOC, i.e. the state of charge of the battery 4, and a threshold for starting motoring control and a threshold for stopping the motoring control are determined separately, consumption of energy taken out from the battery 4 can be limited without utilizing complicated control operations and at the same time preventing overcharging of the battery 4.

The energy consumed resulting from motoring of the engine 2 executed by the motoring control means 8 is greater than the amount of power generated by the regenerative power generation.

Accordingly, since overcharging the battery 4 can be prevented, a long service life of the battery 4 is ensured.

Moreover, the system 1 comprises the power generation control means 12 for starting power generation by running the engine 2 when the state of charge of the battery 4 has reached the third set value e3 lower than the second set value e2 and stopping the power generation when the state of charge of the battery 4 has reached the fourth set value e4 also lower than the second set value e2.

Accordingly, engine motoring control during regeneration and control of power generation by the engine 2 can be separately performed.

### LIST OF REFERENCE NUMERALS

1 . . . hybrid system
2 . . . engine
3 . . . generator (also referred to as “MG1”)
4 . . . battery
5 . . . motor (also referred to as “MG2”)
6 . . . output shaft
7 . . . drive shaft
8 . . . motoring control means (also referred to as “control unit”)
9 . . . accelerator pedal position sensor
10 . . . brake pedal position sensor
11 . . . vehicle speed sensor
12 . . . power generation control means (also referred to as “BMU” or “battery management unit”)
e1 . . . first set value
e2 . . . second set value
e3 . . . third set value
e4 . . . fourth set value
e5 . . . fifth set value
e6 . . . sixth set value

Claimed features not reciting the word “means” are intended not to be features governed by the sixth paragraph of 35 U.S.C. ¶ 112.

What is claimed is:

1. A hybrid vehicle comprising an engine; a generator for generating electrical power from the driving force of said engine; a battery charged with electrical power generated by said generator; and a motor driven by electrical power generated by said generator or by electrical power output from said battery, said hybrid vehicle further comprising motoring control means for starting motoring of said engine in addition to regenerative power generation when a state of charge of said battery reaches a first set value and stopping the motoring of said engine when the state of charge of said battery reaches a second set value lower than the first set value.

2. The vehicle of claim 1, wherein the power consumed by motoring of said engine executed by said motoring control means is larger than the amount of power generated by regenerative power generation.

3. The vehicle of claim 1, further comprising power generation control means for starting power generation by operating said engine when a state of charge of said battery becomes higher than a third set value lower than the second set value and stopping power generation by said engine when the state of charge of said battery reaches a fourth set value higher than the third set value and lower than the second set value.

4. A hybrid vehicle comprising an engine; a generator for generating electrical power from the driving force of said engine; a battery charged with electrical power generated by said generator; and a motor driven by electrical power generated by said generator or by electrical power output from said battery, said hybrid vehicle further comprising a motoring control unit for starting motoring of said engine in addition to regenerative power generation when a state of charge of said battery reaches a first set value and stopping the motoring of said engine when the state of charge of said battery reaches a second set value lower than the first set value.

5. The vehicle of claim 4, wherein the power consumed by motoring of said engine executed by said motoring control unit is larger than the amount of power generated by regenerative power generation.

6. The vehicle of claim 4, further comprising a battery management unit for starting power generation by operating said engine when a state of charge of said battery becomes higher than a third set value lower than the second set value and stopping power generation by said engine when the state of charge of said battery reaches a fourth set value higher than the third set value and lower than the second set value.
